(19) United States
(12) Patent Application Publication
(10) Pub. No.: US 2025/0108978 A1
(43) Pub. Date: Apr. 3, 2025

(54) BELT SUPPORTING ROLL, AND BELT ROTATING DEVICE AND PROCESSING SYSTEM INCLUDING BELT SUPPORTING ROLL

(71) Applicant: FUJIFILM Business Innovation Corp., Tokyo (JP)

(72) Inventors: Kotaro ARAKI, Kanagawa (JP); Shogo Kamiya, Kanagawa (JP); Shingo Akiyama, Kanagawa (JP)

(73) Assignee: FUJIFILM Business Innovation Corp., Tokyo (JP)

(21) Appl. No.: 18/424,177

(22) Filed: Jan. 26, 2024

(30) Foreign Application Priority Data
Sep. 28, 2023 (JP) 2023-168653

(51) Int. Cl. B65G 39/20; B65G 39/16; B65G 43/04

(52) U.S. Cl. CPC B65G 39/20; B65G 39/16; B65G 43/04; B65G 2203/0283

(57) ABSTRACT

A belt supporting roll configured to support an endless belt while allowing the belt to rotate includes: a roll body around which the belt is to be wrapped; a holding component extending in an axial direction of the roll body and holding two ends of the roll body while allowing the roll body to rotate; and a supporting component provided at a lengthwise central part of the holding component and supporting the roll body and the holding component while being movable. The supporting component has a range of motion containing a first directional component and a second directional component. The first directional component intersects a bisector of a central angle of an angular range by which the belt is to be wrapped around the roll body. The second directional component is parallel to the bisector.

### CROSS-REFERENCE TO RELATED APPLICATIONS

This application is based on and claims priority under 35 USC 119 from Japanese Patent Application No. 2023-168653 filed Sep. 28, 2023.

### BACKGROUND

### (i) Technical Field

The present disclosure relates to a belt supporting roll and to a belt rotating device and a processing system each including the belt supporting roll.

### (ii) Related Art

In known arts, belt rotating devices have already been disclosed by, for example, Japanese Unexamined Patent Application Publication No. 2015-156044 (Description of Embodiments, FIG. 4) and Japanese Unexamined Patent Application Publication No. 8-192934 (Description of Embodiments, FIG. 1).

According to Japanese Unexamined Patent Application Publication No. 2015-156044, a belt transporting device includes first and second adjusting members, and a linking component. The first and second adjusting members are provided on two respective sides, in the widthwise direction of a belt, of one of stretching members and are movable when receiving a force from the belt. The linking component is configured to link the movement of the first adjusting member and the movement of the second adjusting member to each other. If the belt is skewed toward a first-end side, the first adjusting member moves by receiving a force from the belt and causes the linking component to move the second adjusting member, whereby the one stretching member tilts relative to the other stretching members.

According to Japanese Unexamined Patent Application Publication No. 8-192934, a belt transporting device includes rotatable rolls around which an endless belt is rotatably stretched. One of the rotatable rolls serves as a displaceable roll (displaceable along a hard axis X and a soft axis Y) configured to be displaced in correspondence with the movement of the endless belt in the axial direction of the rotatable roll.

### SUMMARY

Aspects of non-limiting embodiments of the present disclosure relate to adjusting any widthwise skew of a belt in an appropriate manner and with a simple configuration by using a belt supporting roll that is rockable three-dimensionally about an axis of rocking defined at an axially central part of the belt supporting roll, compared with the case of using a belt supporting roll that is rockable two-dimensionally.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a belt supporting roll configured to support an endless belt while allowing the belt to rotate. The belt supporting roll includes: a roll body around which the belt is to be wrapped; a holding component extending in an axial direction of the roll body and holding two ends of the roll body while allowing the roll body to rotate; and a supporting component provided at a lengthwise central part of the holding component and supporting the roll body and the holding component while being movable, wherein the supporting component has a range of motion containing a first directional component and a second directional component, the first directional component intersecting a bisector of a central angle of an angular range by which the belt is to be wrapped around the roll body, the second directional component being parallel to the bisector.

### BRIEF DESCRIPTION OF THE DRAWINGS

An exemplary embodiment of the present disclosure will be described in detail based on the following figures, wherein:

FIG. 1 illustrates a general embodiment of a belt rotating device including a belt supporting roll to which the present disclosure is applied;

FIG. 2A illustrates Representative Use I of the belt rotating device illustrated in FIG. 1;

FIG. 2B illustrates Representative Use II of the belt rotating device illustrated in FIG. 1;

FIG. 3 illustrates an overall configuration of an image forming system serving as a processing system according to an exemplary embodiment;

FIG. 4 illustrates a fixing device according to the exemplary embodiment;

FIG. 5A is a perspective view of a belt unit serving as a belt rotating device included in the fixing device according to the exemplary embodiment;

FIG. 5B illustrates a section taken along line VB-VB given in FIG. 5A;

FIG. 6A illustrates the belt unit seen in the direction of arrow VI given in FIG. 5A;

FIG. 6B is a perspective view of a supporting structure provided for a correcting stretch roll;

FIG. 7A illustrates how the correcting stretch roll according to the exemplary embodiment behaves;

FIG. 7B illustrates the ease of assembly and maintenance of the supporting structure provided for the correcting stretch roll according to the exemplary embodiment;

FIG. 8A is a diagram of an exemplary belt unit including a correcting stretch roll and a fixed stretch roll between which a belt is stretched, and illustrates a first directional component D1;

FIG. 8B is a three-dimensional illustration of FIG. 8A;

FIG. 8C is a diagram of the exemplary belt unit and illustrates a second directional component D2;

FIG. 8D is a three-dimensional illustration of FIG. 8C;

FIG. 8E illustrates a first exemplary behavior of the belt that occurs when the correcting stretch roll is tilted in the second directional component D2;

FIG. 8F illustrates a second exemplary behavior of the belt that occurs when the correcting stretch roll is tilted in the second directional component D2;

FIG. 9 illustrates relevant elements of a belt unit of a belt rotating device included in a fixing device according to a comparative embodiment;

FIG. 10A illustrates relevant elements of a supporting structure provided for a correcting stretch roll according to Modification 1;

FIG. 10B illustrates relevant elements of a supporting structure provided for a correcting stretch roll according to Modification 2;

FIG. 11A illustrates a first exemplary use (an active steering scheme) of the fixing device according to the exemplary embodiment;

FIG. 11B illustrates an exemplary configuration of a position sensor illustrated in FIG. 11A;

FIG. 11C illustrates an exemplary configuration of an eccentric cam included in a tilt adjusting mechanism illustrated in FIG. 11A;

FIGS. 12A and 12B each illustrate an exemplary behavior of the correcting stretch roll;

FIG. 13A illustrates relevant elements employed in a second exemplary use (a passive steering scheme) of the fixing device according to the exemplary embodiment;

FIG. 13B illustrates an exemplary behavior in the second exemplary use;

FIG. 14A illustrates an exemplary configuration based on the passive steering scheme illustrated in FIG. 13A, seen in the direction of arrow XIVA given in FIG. 13A;

FIG. 14B illustrates details of part XIVB illustrated in FIG. 13A;

FIG. 15A illustrates another exemplary configuration based on the passive steering scheme illustrated in FIG. 13A, seen in the direction of arrow XVA given in FIG. 13A; and

FIG. 15B illustrates details of part XVB illustrated in FIG. 13A.

### DETAILED DESCRIPTION

### General Embodiment

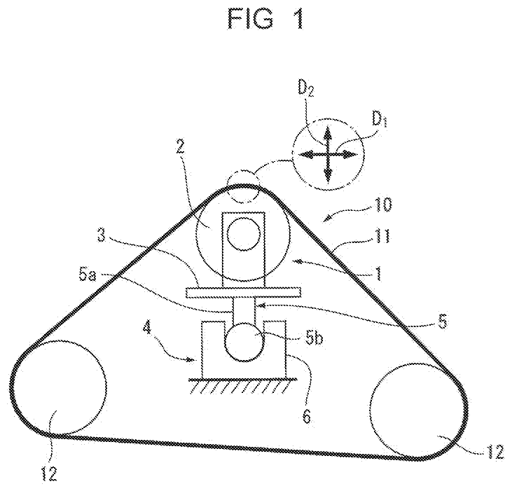

FIG. 1 illustrates a general embodiment of a belt rotating device including a belt supporting roll to which the present disclosure is applied.

Referring to FIG. 1, a belt rotating device 10 includes an endless belt 11 and a plurality of belt supporting rolls 1 and 12, which support the belt 11 while allowing the belt 11 to rotate. One of the plurality of belt supporting rolls 1 and 12 (in the general embodiment, the belt supporting roll 1) is configured as follows.

The belt supporting roll 1 includes a roll body 2, a holding component 3, and a supporting component 4. The belt 11 is to be wrapped around the roll body 2. The holding component 3 extends in the axial direction of the roll body 2 and holds the two ends of the roll body 2 while allowing the roll body 2 to rotate. The supporting component 4 is provided at a lengthwise central part of the holding component 3 and supports the roll body 2 and the holding component 3 while being movable. The supporting component 4 has a range of motion containing a first directional component D1 and a second directional component D2. The first directional component D1 intersects the bisector of the central angle of the angular range by which the belt 11 is to be wrapped around the roll body 2. The second directional component D2 is parallel to the bisector.

In the above technical feature, the general embodiment is applicable to any of the belt supporting rolls configured to support the belt 11 while allowing the belt 11 to rotate, and the applicable belt supporting roll includes the roll body 2, the holding component 3, and the supporting component 4.

The roll body 2 may be either hollow or solid. The wrap angle at which the belt 11 is to be wrapped around the roll body 2 may be determined as appropriate. The holding component 3 may be in any form as long as the holding component 3 includes an elongated member having a flat shape, for example, and extending in the axial direction of the roll body 2 and holds, at the two sides of the elongated member, the two respective ends of the roll body 2 while allowing the roll body 2 to rotate. The supporting component 4 may be in any form as long as the supporting component 4 is provided at a lengthwise central part of the holding component 3 and supports the roll body 2 and the holding component 3 while being movable three-dimensionally.

The belt supporting roll 1 rocks three-dimensionally because of differences between the two axial ends of the belt supporting roll 1 in terms of the alignment of the belt supporting roll 1 and the tension and the frictional force of the belt 11.

The general embodiment is particularly effective in increasing the number of rolls for stretching the belt 11 and in reducing the diameter of the belt supporting roll 1.

If the number of rolls for stretching the belt 11 is increased, the belt supporting roll 1 is more likely to tilt three-dimensionally because of, for example, possible misalignment between the rolls.

If a roll with a small diameter is employed as the belt supporting roll 1 or 12, the wrap angle (belt-wrapping angle) of the small-diameter roll is small. Consequently, the ease of controlling the walk of the belt 11 tends to be reduced.

On the other hand, the supporting component 4 serves as a structure that supports the roll while being movable three-dimensionally and therefore needs to have a range of motion containing the first directional component D1 and the second directional component D2. Herein, the term “first directional component D1” refers to a directional component in which the belt 11 may twist, and the term “second directional component D2” refers to a directional component in which the belt 11 may expand or contract.

A representative example of the belt supporting roll 1 according to the general embodiment will now be described.

The representative example of the belt supporting roll 1 includes a shaft member 5 and a bearing member 6. The shaft member 5 is positioned at the lengthwise central part of the holding component 3 and across the holding component 3 from the roll body 2. The shaft member 5 includes a spherical part 5b, which has a spherical outer peripheral surface. The bearing member 6 bears the spherical part 5b of the shaft member 5 while allowing the spherical part 5b to rotate three-dimensionally.

In the representative example, considering the ease of arrangement, the supporting component 4 may be oriented with the shaft member 5 facing the holding component 3 and with the bearing member 6 being positioned on a predetermined fixed part.

In such an orientation, the shaft member 5 may include a projecting part 5a, which projects from the lengthwise central part of the holding component 3, with the spherical part 5b being provided as a portion of the projecting part 5a in such a manner as to protrude spherically.

The spherical part 5b may be provided at a halfway position of the projecting part 5a or at an end of the projecting part 5a.

A representative example of the bearing member 6 may, but is not limited to, have a spherical bearing surface that holds the spherical part 5b in such a manner as to surround the spherical part 5b while allowing the spherical part 5b to rotate.

The bearing member 6 may be a cylindrical member having an inner peripheral bearing surface that circumscribes the spherical part 5b of the shaft member 5.

Employing such a bearing member 6 may make the shaft member 5 and the bearing member 6 detachable from each other.

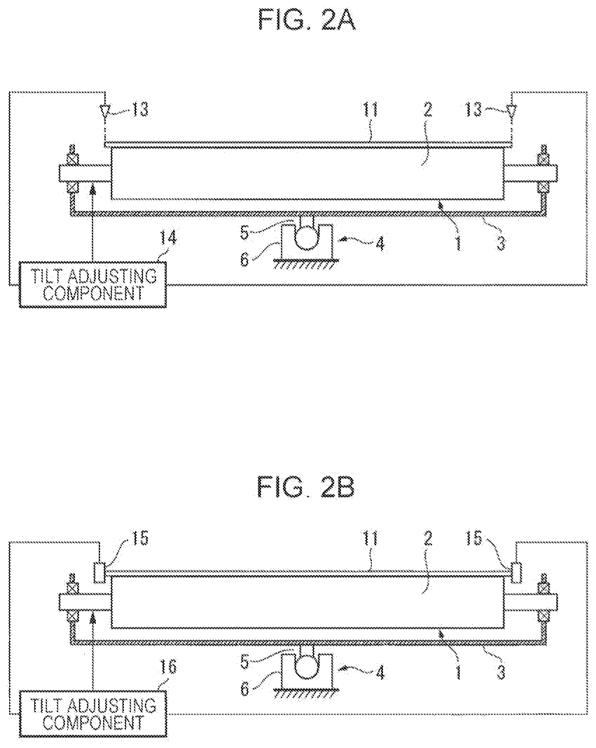

FIG. 2A illustrates Representative Use I, taken as a prevention for the skewing of the belt 11 in the belt rotating device 10. In Representative Use I, the belt rotating device 10 includes detectors 13 and a tilt adjusting component 14. The detectors 13 are configured to detect any skew of the belt 11 in the widthwise direction that intersects the direction of rotation of the belt 11. The tilt adjusting component 14 is configured to adjust, with reference to the result of detection by the detectors 13, the tilt of the belt supporting roll 1 in such a manner as to reduce the skew of the belt 11.

FIG. 2B illustrates Representative Use II, taken as another prevention for the skewing of the belt 11 in the belt rotating device 10. In Representative Use II, the belt rotating device 10 includes edge receiving components 15 and a tilt adjusting component 16. The edge receiving components 15 are provided facing the two respective widthwise edges of the belt 11 and are movable in the widthwise direction of the belt 11. The edge receiving components 15 are moved by the belt 11 if the belt 11 is skewed widthwise. The tilt adjusting component 16 is configured to adjust, in correspondence with the lengths of movements of the edge receiving components 15, the tilt of the belt supporting roll 1 in such a manner as to reduce the skew of the belt 11.

In Use II illustrated in FIG. 2B, the tilt adjusting component 16 may include a linking component (not illustrated) and elastic supporting components (not illustrated). The linking component is configured to tilt the belt supporting roll 1 in conjunction with the movement of the edge receiving components 15. The elastic supporting components support the two respective ends of the belt supporting roll 1 while being elastically deformable. The elastic supporting components may be configured to adjust, if the belt supporting roll 1 is tilted by the linking component, the tilt of the belt supporting roll 1 with elastic restoring forces exerted by the elastic supporting components undergoing elastic deformations.

In Use II, to keep the two widthwise edges of the belt 11 be in contact with the edge receiving components 15 in a good manner, the edge receiving components 15 may be positioned on a virtual line parallel to the axis of the belt supporting roll 1, and the elastic supporting components may keep exerting pressures in such a manner as to press the respective edge receiving components 15 against the two respective widthwise edges of the belt 11.

The belt supporting roll 1 included in such a belt rotating device 10 is suitable as, but is not limited to, a steering roll and may include a tension adjusting component (not illustrated) configured to urge the belt 11 in the second directional component D2. In that case, the belt supporting roll 1 serving as a steering roll may also serve as a tension roll (tension applying roll) configured to apply a tension to the belt 11.

Such a belt rotating device 10 is applicable to various uses. In any use, the belt rotating device 10 may include a processing component (not illustrated) configured to perform a predetermined processing operation on a workpiece (not illustrated) that moves by being in contact with the belt 11. Examples of the processing component include a heating component, a cooling component, and a transfer component that is configured to transfer an image from the belt 11 to a medium regarded as a workpiece.

Such a belt rotating device 10 (including the processing component) may be included in a processing system together with a transporting component (not illustrated) configured to transport a workpiece to the belt rotating device 10 and to transport the workpiece processed on the belt rotating device 10.

The present disclosure will further be described in detail, providing an exemplary embodiment illustrated in other accompanying drawings.

### Exemplary Embodiment

### Overall Configuration of Image Forming System

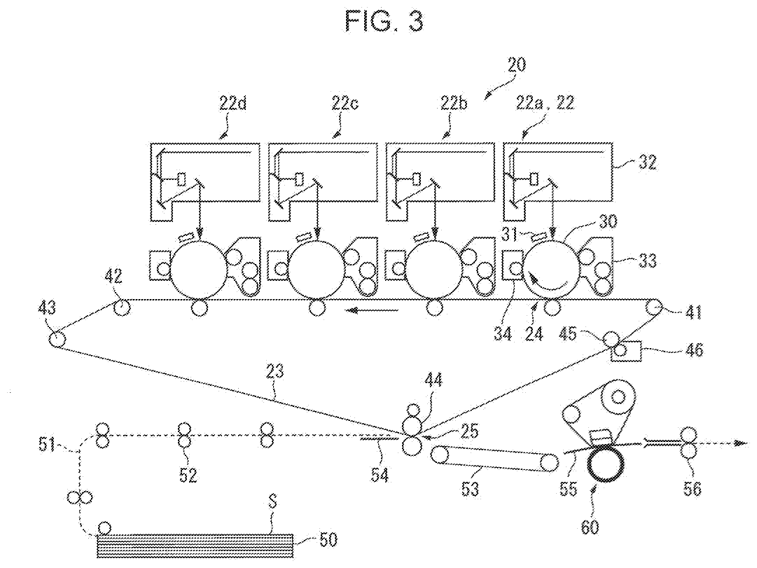

FIG. 3 illustrates an overall configuration of a processing system according to an exemplary embodiment.

The processing system illustrated in FIG. 3 is configured as an image forming system 20. The image forming system 20 includes an imaging component configured to form an unfixed image on a medium S, and a fixing device serving as a belt rotating device and configured to fix the unfixed image formed on the medium S.

In the present exemplary embodiment, the image forming system 20 is of a so-called tandem type and employs an intermediate transfer scheme. The image forming system 20 includes a common unit (not illustrated) in which elements forming the imaging component and the fixing device are provided. Needless to say, the imaging component and the fixing device may alternatively be provided as separate units to be combined for use.

In the present exemplary embodiment, the image forming system 20 includes a plurality of image forming units 22 (22a to 22d), which are configured to electrophotographically form respective toner images in respective color components (in the present exemplary embodiment, four colors of yellow (Y), magenta (M), cyan (C), and black (K)). A belt-type intermediate transfer body 23 is provided facing the image forming units 22. First-transfer devices 24 (in the present exemplary embodiment, first-transfer rolls) are provided on the inner surface of the intermediate transfer body 23 at positions corresponding to the respective image forming units 22. A second-transfer device 25 (in the present exemplary embodiment, a second-transfer roll) is provided at another position of the intermediate transfer body 23. The second-transfer device 25 is configured to perform a second-transfer process in which the color-component toner images transferred by the first-transfer devices 24 from the image forming units 22 to the intermediate transfer body 23 in a first-transfer process are transferred to a medium S, which is paper or the like. A fixing device 60 is provided on the downstream side relative to the second-transfer device 25 in the direction of transport of the medium S having the color-component toner images transferred thereto. The fixing device 60 is configured to fix the toner images (corresponding to an unfixed image) that are yet to be fixed on the medium S.

In the present exemplary embodiment, a combination of the plurality of image forming units 22, the intermediate transfer body 23, the first-transfer devices 24, and the second-transfer device 25 corresponds to the imaging component configured to form an unfixed image on a medium S.

### Image Forming Units

The image forming units 22 each include a drum-type photoconductor 30, which is configured to rotate in a predetermined direction. Around the photoconductor 30 are provided a charging device 31, an exposure device 32, a developing device 33, and a cleaning device 34. The charging device 31 is configured to charge the photoconductor 30. The exposure device 32 is a laser scanning device or the like and is configured to form an electrostatic latent image on the photoconductor 30 charged by the charging device 31. The developing device 33 is configured to develop, with a corresponding one of the color toners, the electrostatic latent image formed on the photoconductor 30 by the exposure device 32 into a toner image. The cleaning device 34 is configured to remove residual matter from the photoconductor 30 having undergone the first-transfer process in which the toner image developed by the developing device 33 is transferred to the intermediate transfer body 23 by the first-transfer device 24.

### Intermediate Transfer Body and Peripheral Elements

The intermediate transfer body 23 is stretched around a plurality of stretch rolls 41 to 45 and is to be rotated in a predetermined direction by a driving roll, which is, for example, the stretch roll 41. The stretch roll 44 also serves as a counter roll for the second-transfer roll serving as the second-transfer device 25. A second-transfer electric field is to be generated for the second-transfer process between the second-transfer roll and the counter roll. An intermediate-transfer cleaning device 46 is provided on the outer surface of the intermediate transfer body 23 at a position corresponding to the stretch roll 45.

### Medium Transporting System

A medium supplying device 50 is provided below the intermediate transfer body 23. A medium S is supplied from the medium supplying device 50 and is transported along a transport path 51, which runs through the second-transfer device 25 and reaches the fixing device 60. The transport path 51 is provided with an appropriate number of transporting rolls 52, a transporting belt 53, guiding plates 54 and 55, a discharging roll 56, and so forth. The transporting belt 53 is to transport the medium S from the second-transfer device 25 to the fixing device 60. The guiding plates 54 and 55 are to guide the medium S to a second-transfer site defined at the second-transfer device 25 and to a fixing site defined at the fixing device 60. The discharging roll 56 is to discharge the medium S to a medium receiving part (not illustrated).

### Overall Configuration of Fixing Device

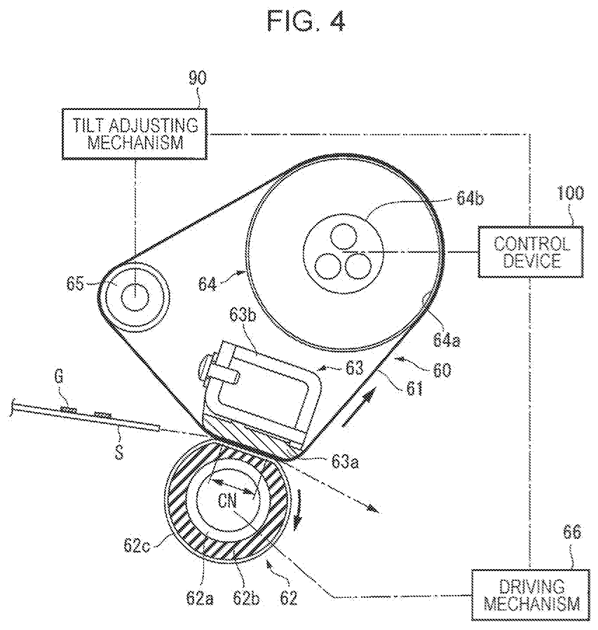

The fixing device 60 employed in the present exemplary embodiment will now be described with reference to FIG. 4.

The fixing device 60 illustrated in FIG. 4 includes a fixing belt 61, a pressure roll 62, a pressing pad 63, a heat roll 64, and a correcting stretch roll 65. The fixing belt 61 is made of a heat-resistant material and is to be rotated. The pressure roll 62 is in contact with the outer surface of the fixing belt 61 at a fixing area of the fixing belt 61. The pressing pad 63 is in contact with the inner surface of the fixing belt 61 at a position across from the pressure roll 62, thereby defining a contact area CN, where the medium S is to be transported while being nipped between the pressure roll 62 and the fixing area of the fixing belt 61. The heat roll 64 stretches the fixing belt 61 while allowing the fixing belt 61 to rotate, at a position on the downstream side relative to the contact area CN in the direction of rotation of the fixing belt 61. The heat roll 64 is configured to heat the fixing belt 61 while being in contact with the fixing belt 61. The correcting stretch roll 65 stretches the fixing belt 61 while allowing the fixing belt 61 to rotate, at a position on the upstream side relative to the contact area CN in the direction of rotation of the fixing belt 61. The correcting stretch roll 65 serves as a belt supporting roll that is configured to correct any skew of the fixing belt 61.

In the present exemplary embodiment, the fixing belt 61, the pressing pad 63, the heat roll 64, and the correcting stretch roll 65 are assembled into a belt unit, and the belt unit is positioned facing the pressure roll 62.

### Fixing Belt

The fixing belt 61 includes a base member made of a heat-resistant resin material such as polyimide (PI) resin. The outer surface of the base member is covered with an elastic layer made of silicon rubber or the like, and a release layer made of fluorine-based resin. The fixing belt 61 has, in general, low thermal conductivity in the thicknesswise direction and the planar direction thereof.

### Pressure Roll

The pressure roll 62 includes a metal roll 62a, around which an elastic member 62b is provided. The elastic member 62b is made of urethane rubber or the like. The outer surface of the elastic member 62b is covered with a protective layer 62c.

In the present exemplary embodiment, the pressure roll 62 is supported at two end shafts of the metal roll 62a with the aid of respective bearings, thereby being rotatable. The pressure roll 62 is to be rotated by a driving mechanism 66.

### Pressing Pad

The pressing pad 63 serves as a receiving member provided in contact with the inner surface of the fixing belt 61. The pressing pad 63 includes a pad body 63a and a holder base 63b. The pad body 63a has a flat shape and is made of liquid crystal polymer or the like. The holder base 63b holds the pad body 63a and is a substantially rectangular hollow pipe.

In the present exemplary embodiment, the pad body 63a is harder than the elastic member 62b of the pressure roll 62. The contact area CN between the fixing belt 61 and the pressure roll 62 is defined such that the pressure roll 62 is compressed at the contact area CN.

In the present exemplary embodiment, the pressure roll 62 serves as a driving roll of the fixing device 60. Therefore, the fixing belt 61 nipped at the contact area CN between the pressure roll 62 and the pressing pad 63 is to rotate by following the pressure roll 62.

### Heat Roll

The heat roll 64 includes a roll body 64a, in which a heat source 64b is provided. The heat source 64b includes one or a plurality (three in the present exemplary embodiment) of halogen lamps or the like. The heat roll 64 is held at two end shafts of the roll body 64a with the aid of respective bearings (not illustrated), thereby being rotatable. In the heat roll 64, the peripheral surface of the roll body 64a is in contact with the inner surface of the fixing belt 61 so that heat is to be conducted to the fixing belt 61. Thus, the heat roll 64 heats the fixing belt 61 for the fixing process to be performed at the contact area CN.

Needless to say, the heat roll 64 may have another configuration, instead of including the heat source 64b such as halogen lamps. For example, a resistance heating layer may be provided over the roll body 64a with an insulating layer provided in between, and the resistance heating layer may be heated.

In the present exemplary embodiment, the pressure roll 62 serves as the driving roll. Instead of the pressure roll 62, the heat roll 64 may serve as the driving roll.

### Correcting Stretch Roll

The correcting stretch roll 65 that stretches the fixing belt 61 while allowing the fixing belt 61 to rotate is tiltable and also serves as a so-called steering roll configured to correct any skew of the fixing belt 61.

### Exemplary Configuration of Correcting Stretch Roll

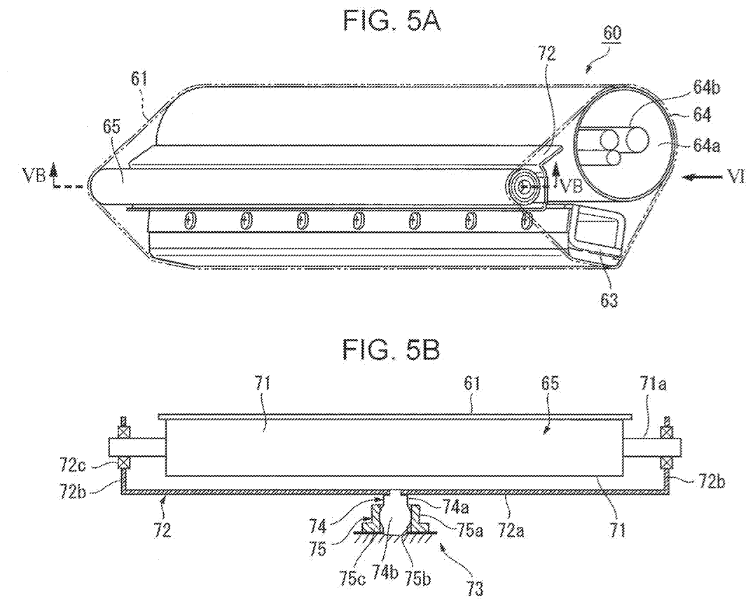

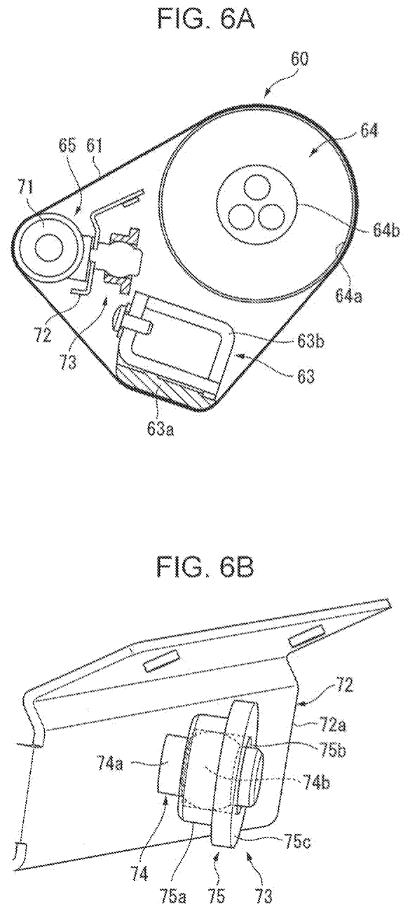

As illustrated in FIGS. 4, 5A, 5B, 6A, and 6B, the correcting stretch roll 65 includes a roll body 71, a holding frame 72, and a support 73. The roll body 71 is made of, for example, metal. The fixing belt 61 is to be wrapped around the roll body 71. The holding frame 72 is made of, for example, metal. The holding frame 72 serves as a holding component extending in the axial direction of the roll body 71 and holding the two ends of the roll body 71 while allowing the roll body 71 to rotate. The support 73 serves as a supporting component provided at a lengthwise central part of the holding frame 72 and supporting the roll body 71 and the holding frame 72 while being movable.

### Roll Body and Holding Frame

In the present exemplary embodiment, the roll body 71 is provided at the two lengthwise ends thereof with respective rotation shafts 71a. On the other hand, the holding frame 72 includes a base frame member 72a and a pair of side frame members 72b. The base frame member 72a has a flat shape and is provided at the back of the roll body 71 but is out of contact with the roll body 71. The roll body 71 is in contact with the fixing belt 61. The side frame members 72b are provided at the two respective lengthwise sides of the base frame member 72a. The side frame members 72b of the holding frame 72 have respective insertion holes, which receive rotation shafts, 71a, of the roll body 71. The rotation shafts 71a of the roll body 71 are held in the insertion holes with the aid of respective bearings 72c, thereby being rotatable.

### Support

In the present exemplary embodiment, the support 73 includes a shaft member 74 and a bearing member 75. The shaft member 74 is positioned at a lengthwise central part of the base frame member 72a of the holding frame 72 and across the base frame member 72a from the roll body 71. The bearing member 75 is positioned on a predetermined fixed part and receives the shaft member 74 while allowing the shaft member 74 to rotate.

The shaft member 74 is an integrally formed member made of, for example, a special-use stainless steel called SUS and includes a projecting part 74a and a spherical part 74b. The projecting part 74a has a round columnar shape and projects from the back face of the base frame member 72a of the holding frame 72 at the lengthwise central part of the base frame member 72a. The spherical part 74b is provided at a halfway position of the projecting part 74a in such a manner as to protrude forming a spherical outer peripheral surface.

In the present exemplary embodiment, the proximal end of the projecting part 74a of the shaft member 74 is fixed to the lengthwise central part of the base frame member 72a of the holding frame 72. The technique of fixing the shaft member 74 to the base frame 72a may be selected as appropriate from screwing, crimping, welding, and the like.

The bearing member 75 is an integrally formed member made of, for example, polyphenylene sulfide (PPS) and may be a cylindrical member 75a. The cylindrical member 75a has an inner peripheral bearing surface 75b, which circumscribes the spherical part 74b of the shaft member 74. The cylindrical member 75a further has a flange 75c around a periphery at an end thereof that faces the fixed part. The flange 75c is fixed to the fixed part with a fastening member (not illustrated).

The distal end of the projecting part 74a of the shaft member 74 passes through the inner peripheral bearing surface 75b of the cylindrical member 75a serving as the bearing member 75, but is out of contact with the fixed part.

### Functions of Supporting Structure for Correcting Stretch Roll

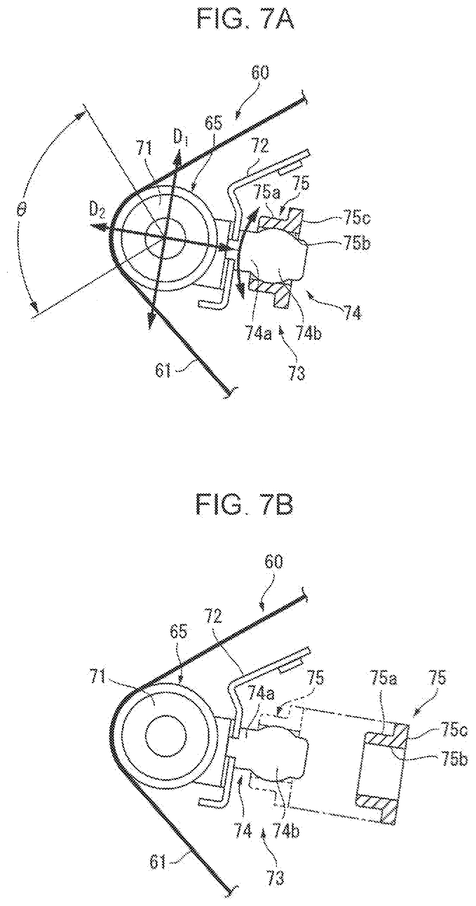

As illustrated in FIG. 7A, in the support 73 of the correcting stretch roll 65 according to the present exemplary embodiment, the periphery of the spherical part 74b of the shaft member 74 is circumscribed by the inner peripheral bearing surface 75b of the cylindrical member 75a serving as the bearing member 75. Therefore, the shaft member 74 is three-dimensionally rockable in any direction relative to the bearing member 75, with the spherical part 74b acting as the pivot.

In other words, the center line of the shaft member 74 of the support 73 is regarded as the axis of rocking that passes through the pivot defined in the spherical part 74b. Therefore, it is understood that the correcting stretch roll 65 is rotatable not only in a plane perpendicular to the axis of rocking but also in a direction angled to the perpendicular plane.

Referring to FIG. 7A, letting a direction intersecting the bisector of the central angle, θ, of the angular range by which the fixing belt 61 is wrapped around the roll body 71 be denoted as a first directional component D1; and a direction parallel to the bisector be denoted as a second directional component D2, the first directional component D1 is regarded as a direction in which the fixing belt 61 may twist. Furthermore, the second directional component D2 is regarded as a direction in which the fixing belt 61 may expand or contract.

Accordingly, in the present exemplary embodiment, the support 73 of the correcting stretch roll 65 is regarded as having a range of motion containing the first directional component D1 and the second directional component D2.

Hence, in the operation of correcting any skew of the fixing belt 61, the correcting stretch roll 65 is allowed to undergo a three-dimensional tilting motion.

### Supplementary Description of First Directional Component D1 and Second Directional Component D2

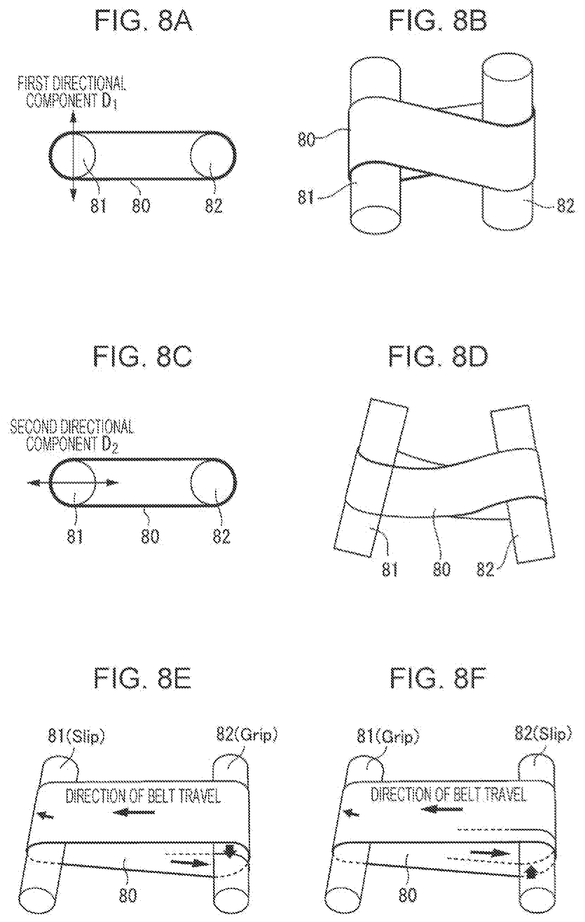

Referring now to FIGS. 8A to 8F, the first directional component D1 and the second directional component D2 will supplementarily be described, taking a case of a belt unit in which a belt 80 is stretched between a tiltable correcting stretch roll 81 and a nontiltable fixed stretch roll 82.

FIG. 8A illustrates a state where one end of the correcting stretch roll 81 is moved in the first directional component D1. This state is illustrated three-dimensionally in FIG. 8B. FIG. 8B only illustrates a geometrical parameter representing how much the belt 80 is twisted, ignoring other factors such as friction.

FIG. 8C illustrates a state where one end of the correcting stretch roll 81 is moved in the second directional component D2. This state is illustrated three-dimensionally in FIG. 8D. Such a state is determined by the balance between an external force that tends to deform the belt 80 (a frictional force generated between the roll and the belt) and an internal force that tends to keep the belt 80 in its original shape (a restoring force).

Here, the walk (skew) of the belt 80 in the second directional component D2 will be discussed. The walk of the belt 80 in the first directional component D1 is already known and is not discussed herein.

As illustrated in FIGS. 8C and 8D, when one end of the correcting stretch roll 81 is moved in the second directional component D2, the belt 80 travels perpendicularly to the axial direction of the correcting stretch roll 81.

In this state, referring to FIG. 8E, if the fixed stretch roll 82 is not slippery (expressed as “Grip” in the drawing), the fixed stretch roll 82 transports the belt 80 in a direction that follows the direction of the tilt of the belt 80 at the correcting stretch roll 81 located on the upstream side. Accordingly, at the fixed stretch roll 82, the belt 80 walks downward in the drawing relative to the original position of the belt 80.

In contrast, referring to FIG. 8F, if the fixed stretch roll 82 is slippery (expressed as “Slip” in the drawing), while the position of the belt 80 tilted at the correcting stretch roll 81 on the upstream side is not changed, the fixed stretch roll 82 transports the belt 80 in a direction perpendicular to the axial direction of the fixed stretch roll 82. Accordingly, at the fixed stretch roll 82, the belt 80 walks upward in the drawing relative to the original position of the belt 80.

### Ease of Assembly and Maintenance of Correcting Stretch Roll

In the support 73 of the correcting stretch roll 65 according to the present exemplary embodiment, the shaft member 74 includes the spherical part 74b provided at a halfway position of the projecting part 74a, and the bearing member 75 as the cylindrical member 75a circumscribing the spherical part 74b at the inner peripheral bearing surface 75b thereof.

In the present exemplary embodiment, the shaft member 74 is detachable from the bearing member 75 in the direction of the axis of rocking.

### Comparative Embodiment

To evaluate the range of tilt of the correcting stretch roll 65 according to the present exemplary embodiment, the range of tilt of a correcting stretch roll 65′ according to a comparative embodiment will now be discussed.

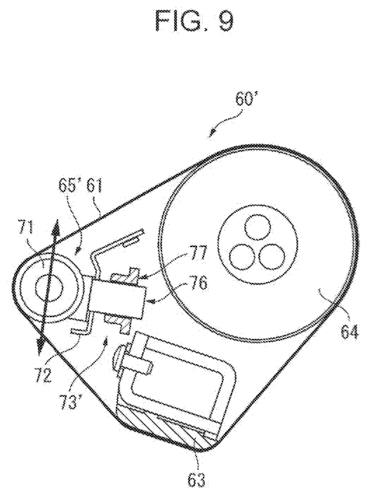

FIG. 9 illustrates a belt unit included in a fixing device 60′ according to the comparative embodiment.

The belt unit of the fixing device 60′ illustrated in FIG. 9 includes the fixing belt 61, the pressing pad 63, and the heat roll 64 as in the exemplary embodiment, but is different from that of the exemplary embodiment in the correcting stretch roll 65′. Elements that are the same as in the exemplary embodiment are denoted by corresponding ones of the reference signs used in the exemplary embodiment and are not described in detail herein.

The correcting stretch roll 65′ according to the comparative embodiment includes the roll body 71 and the holding frame 72 as in the exemplary embodiment, but is different from that of the exemplary embodiment in including a support 73′.

In the support 73′ according to the comparative embodiment, the shaft member is a cylindrical stud 76, and the bearing member is a cylindrical member 77. The cylindrical stud 76 projects from the back face of the base frame member 72a of the holding frame 72 at a lengthwise central part of the base frame member 72a. The cylindrical stud 76 is received by the inner peripheral bearing surface of the cylindrical member 77 while being allowed to rotate.

In the comparative embodiment, the cylindrical stud 76′ serving as the shaft member of the support 73′ is rotatable about the axis of rocking relative to the cylindrical member 77 serving as the bearing member. That is, the rotating motion of the correcting stretch roll 65′ is limited to a rotation in a plane perpendicular to the axis of rocking.

In other words, the correcting stretch roll 65′ according to the comparative embodiment is incapable of undergoing a rotating motion in a direction (the second directional component D2) angled to the plane perpendicular to the axis of rocking. Hence, in the correction of any skew of the fixing belt 61 by using the correcting stretch roll 65′ according to the comparative embodiment, the correction of the skew of the fixing belt 61 (a steering operation) may be defective for a tilt in the second directional component D2.

### Modifications

In the support 73 of the correcting stretch roll 65 according to the exemplary embodiment, the shaft member 74 is fixed to the holding frame 72 and includes the spherical part 74b provided at a halfway position of the projecting part 74a. Furthermore, the bearing member 75 is the cylindrical member 75a. However, the support 73 is not limited to the above and may be modified as Modification 1 or Modification 2 described below.

### Modification 1

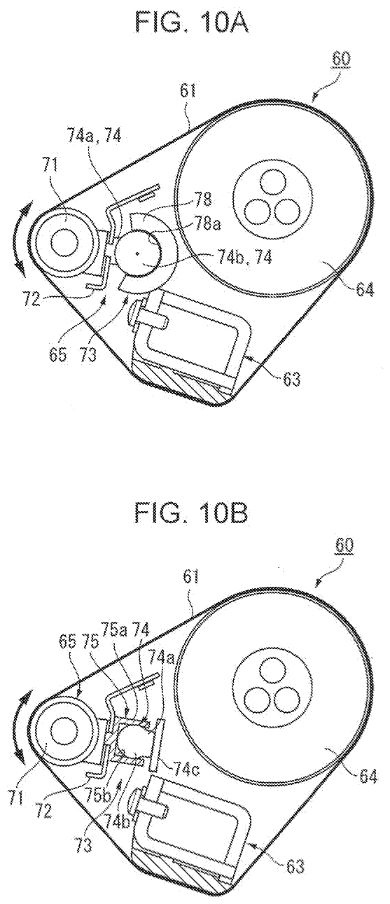

FIG. 10A illustrates a belt unit included in a fixing device 60 according to Modification 1.

The belt unit of the fixing device 60 illustrated in FIG. 10A is substantially the same as that of the exemplary embodiment but is different from that of the exemplary embodiment in the support 73 of the correcting stretch roll 65. Elements that are the same as in the exemplary embodiment are denoted by corresponding ones of the reference signs used in the exemplary embodiment and are not described in detail herein.

The support 73 of the correcting stretch roll 65 according to Modification 1 is configured as follows. The shaft member 74 is fixed to the back face of the base frame member 72a of the holding frame 72 at a lengthwise central part of the base frame member 72a. The shaft member 74 includes the spherical part 74b at the distal end of the projecting part 74a. The bearing member 75 is a ball coupling 78, which has a spherical bearing surface 78a. The ball coupling 78 bears at the bearing surface 78a thereof the spherical part 74b of the shaft member 74 while allowing the spherical part 74b to rotate.

Therefore, the shaft member 74 is three-dimensionally rockable in any direction relative to the ball coupling 78 serving as the bearing member 75, with the spherical part 74b acting as the pivot. In other words, the center line of the shaft member 74 of the support 73 is regarded as the axis of rocking that passes through the pivot defined in the spherical part 74b. Therefore, as in the exemplary embodiment, it is understood that the correcting stretch roll 65 is rotatable not only in a plane perpendicular to the axis of rocking but also in a direction angled to the perpendicular plane.

### Modification 2

FIG. 10B illustrates a belt unit included in a fixing device 60 according to Modification 2.

The belt unit of the fixing device 60 illustrated in FIG. 10B is substantially the same as that of the exemplary embodiment but is different from that of the exemplary embodiment in the support 73 of the correcting stretch roll 65. Elements that are the same as in the exemplary embodiment are denoted by corresponding ones of the reference signs used in the exemplary embodiment and are not described in detail herein.

The support 73 of the correcting stretch roll 65 according to Modification 2 is configured as follows. The cylindrical member 75a serving as the bearing member 75 is fixed to the back face of the base frame member 72a of the holding frame 72 at a lengthwise central part of the base frame member 72a. The shaft member 74 includes the spherical part 74b at the distal end of the projecting part 74a, which has a round columnar shape and is positioned on a predetermined fixed part. The spherical part 74b of the shaft member 74 is circumscribed by the inner peripheral bearing surface 75b of the cylindrical member 75a. Note that the shaft member 74 includes a base plate 74c.

Modification 2 is obtained by exchanging positions between the shaft member 74 and the bearing member 75 that are included in the support 73 according to the exemplary embodiment, and provides substantially the same functions as the exemplary embodiment.

### Control System for Fixing Device

A control device 100, illustrated in FIG. 4, is a microcomputer including various processors. The term “processor” used herein refers to a processor in a broad sense and encompasses general-purpose processors (such as a central processing unit (CPU)) and dedicated processors (such as a graphics processing unit (GPU), an application-specific integrated circuit (ASIC), a field-programmable gate array (FPGA), and a programmable logic device).

In the control device 100 according to the present exemplary embodiment, a heating-pressurization program for the fixing device 60 is installed in advance in a memory (not illustrated). The processors receive operation signals generated through an operation panel (not illustrated) and pieces of information generated by relevant sensors, and execute relevant programs. In the programs, the control device 100 controls predetermined control signals for the heat source 64b of the heat roll 64, the driving mechanism 66, a tilt adjusting mechanism 90, and so forth. The tilt adjusting mechanism 90 is configured to tilt the correcting stretch roll 65 to correct any skew of the fixing belt 61. Details of the tilt adjusting mechanism 90 will be described separately below.

### Fixing Process Performed by Fixing Device

In the present exemplary embodiment, when the fixing device 60 is activated, the control device 100 activates the pressure roll 62 through the driving mechanism 66 and causes the heat source 64b of the heat roll 64 to generate heat, thereby heating the fixing belt 61. Subsequently, in the fixing device 60, the fixing belt 61 heated by the heat roll 64 rotates. When a medium S having an unfixed image G passes through the contact area CN defined between the fixing belt 61 and the pressure roll 62, the unfixed image G on the medium S is heated and pressurized to be fixed.

### Skew Correction for Fixing Belt

### Necessity of Correcting Skew of Fixing Belt

In the present exemplary embodiment, the fixing device 60 includes the belt unit in which the fixing belt 61 is stretched around the pressing pad 63, the heat roll 64, and the correcting stretch roll 65. In the present exemplary embodiment, there may be differences between the two axial ends of each of relevant rolls in terms of the alignment of the heat roll 64 or the correcting stretch roll 65, the tension of the fixing belt 61, and the frictional force generated between the fixing belt 61 and any of the rolls including the heat roll 64. Such differences cause the fixing belt 61 to skew in an intersecting direction (the widthwise direction, for example) intersecting the direction of rotation thereof.

In such a situation, the correcting stretch roll 65 is tilted as appropriate, whereby the skew of the fixing belt 61 is corrected.

### Skew Correcting Technique I for Fixing Belt

As described above, the present exemplary embodiment employs an improved supporting structure for the correcting stretch roll 65 in which the correcting stretch roll 65 is supported with an axially central part thereof being defined as the axis of rocking and in such a manner as to be tiltable three-dimensionally.

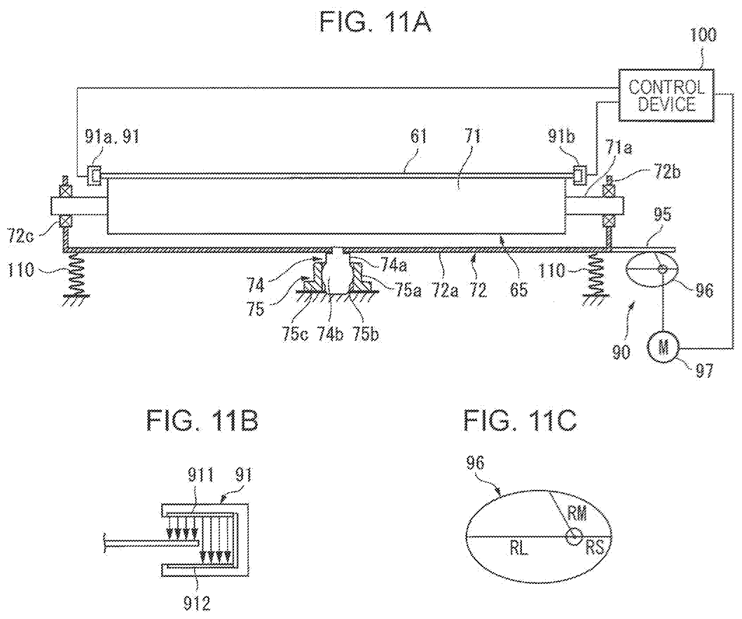

Referring to FIG. 11A, Skew Correcting Technique I for the fixing belt 61 according to the present exemplary embodiment employs the following: the above-described correcting stretch roll 65 (including the roll body 71, the holding frame 72, and the support 73), position sensors 91 (specifically, position sensors 91a and 91b), and the tilt adjusting mechanism 90. The position sensors 91 serve as detectors configured to detect the positions of the two respective widthwise edges of the fixing belt 61. The tilt adjusting mechanism 90 is configured to adjust the orientation of the correcting stretch roll 65 on the basis of information detected by the position sensors 91.

In Skew Correcting Technique I, a pair of urging springs 110 are provided on the back face of the holding frame 72 of the correcting stretch roll 65 at the two respective lengthwise ends of the holding frame 72 in such a manner as to apply a tension to the fixing belt 61.

In Skew Correcting Technique I, as illustrated in FIG. 11B, the position sensors 91 each include a light radiator 911 and a light receiver 912, which face each other with a space provided in between. The space allows a widthwise edge of the fixing belt 61 to enter. The light radiator 911 is configured to radiate measuring light downward through the space. The light receiver 912 is a charge-coupled-device (CCD) array or the like and is configured to receive the measuring light. The amount of light received by the light receiver 912 changes with the position of the widthwise edge of the fixing belt 61 in the space. The position sensor 91 detects such a change and transmits a corresponding detection signal to the control device 100.

In Skew Correcting Technique I, as illustrated in FIG. 11A, the tilt adjusting mechanism 90 includes a cam receiver 95, which has a flat shape and projects outward from one lengthwise end of the holding frame 72 of the correcting stretch roll 65. Furthermore, an eccentric cam 96 is provided in contact with the cam receiver 95 and is to be rotated as appropriate by a driving motor 97.

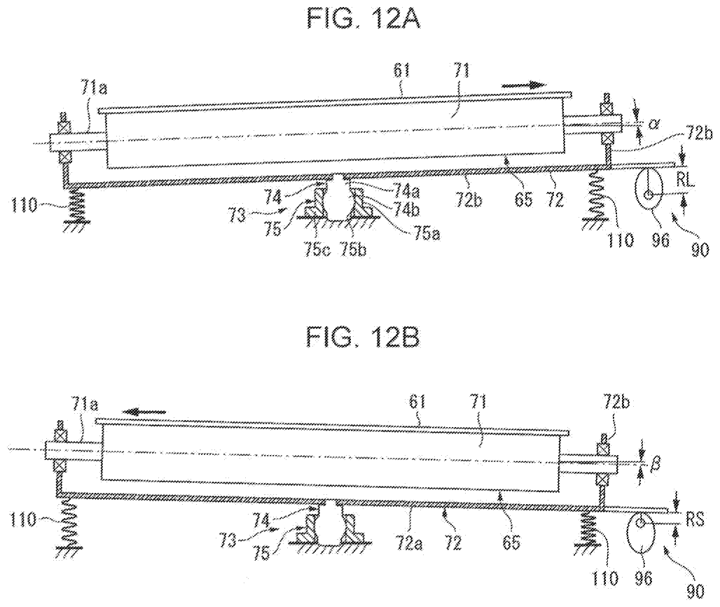

In Skew Correcting Technique I, as illustrated in FIGS. 11A and 11C, the eccentric cam 96 has a short-radius point RS, a long-radius point RL, and a middle-radius point RM, which is defined at the midpoint between the foregoing two. When the eccentric cam 96 is in contact with the cam receiver 95 at the middle-radius point RM, the correcting stretch roll 65 takes an initial orientation, which is horizontal with no tilt. As the contact point of the eccentric cam 96 moves from the middle-radius point RM to the long-radius point RL, as illustrated in FIG. 12A, the correcting stretch roll 65 is tilted such that the right side thereof in the drawing is lifted.

As the contact point of the eccentric cam 96 moves from the middle-radius point RM to the short-radius point RS, as illustrated in FIG. 12B, the correcting stretch roll 65 is tilted such that the left side thereof in the drawing is lifted.

In Skew Correcting Technique I, the control device 100 calculates the amount of skew of the fixing belt 61 with reference to the detection signals received from the position sensors 91. Then, the control device 100 calculates an amount of tilt of the correcting stretch roll 65 that is optimum for correcting the calculated amount of skew of the fixing belt 61, and transmits to the driving motor 97 of the tilt adjusting mechanism 90 a control signal generated with reference to the optimum amount of tilt.

The tilting illustrated in FIG. 12A where the right side, in the drawing, of the correcting stretch roll 65 is lifted by an angle α is executed if the fixing belt 61 is skewed axially leftward in the drawing while traveling along the correcting stretch roll 65.

The tilting illustrated in FIG. 12B where the left side, in the drawing, of the correcting stretch roll 65 is lifted by an angle β is executed if the fixing belt 61 is skewed axially rightward in the drawing while traveling along the correcting stretch roll 65.

To summarize, Skew Correcting Technique I for the fixing belt 61 is an example of a so-called active steering scheme in which the skew of the fixing belt 61 is detected by using the position sensors 91, and the correcting stretch roll 65 is actively tilted by using the tilt adjusting mechanism 90.

### Influences of Reducing Diameter of Correcting Stretch Roll 65

In recent years, the size reduction of image forming systems has been accelerated, which has been accelerating the size reduction of fixing devices. While the size of the fixing device 60 is to be reduced, the size reduction of the heat roll 64 is limited because of the thermal capacity thereof. Hence, the diameter of the correcting stretch roll 65 tends to be reduced. If the diameter of the correcting stretch roll 65 is reduced, the area of contact with the fixing belt 61, that is, the wrap angle, is reduced. If the wrap angle is reduced, simply tilting the correcting stretch roll 65 for skew correction may be not enough to move the fixing belt 61 widthwise, resulting in a reduction in the performance of skew correction. If the performance of skew correction is reduced, the correction of the skew of the fixing belt 61 may fail, leading to a possibility of damage to the fixing belt 61.

In the present exemplary embodiment, the direction in which the correcting stretch roll 65 is movable contains not only the first directional component D1 (the directional component in which the fixing belt 61 may twist) but also the second directional component D2 (the directional component in which the fixing belt 61 may expand or contract).

### Skew Correcting Technique II for Fixing Belt

Skew Correcting Technique II for the fixing belt 61 is different from Skew Correcting Technique I in employing a so-called passive steering scheme in which the correcting stretch roll 65 is tilted by receiving a widthwise force (edge force) applied from the skewed fixing belt 61.

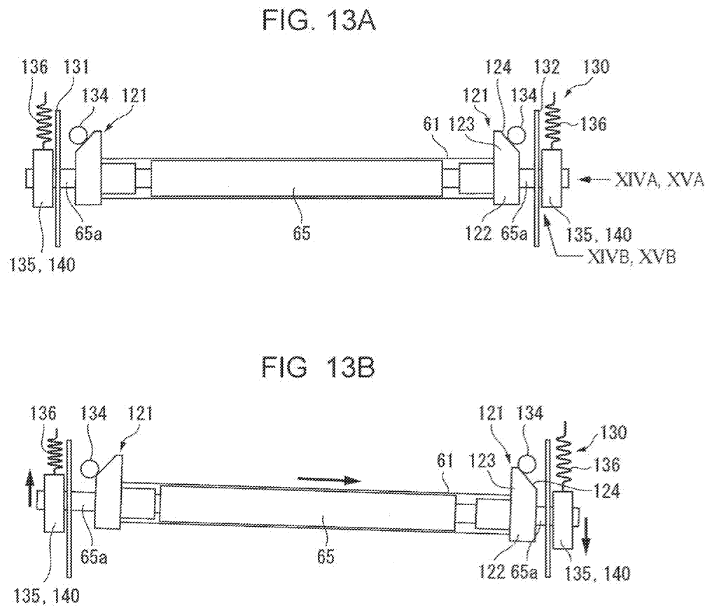

In the supporting structure, not illustrated in FIGS. 13A and 13B, for the correcting stretch roll 65 according to the present exemplary embodiment, the roll body 71 is held by the holding frame 72, and the holding frame 72 is supported by the support 73 (the shaft member 74 and the bearing member 75) at the lengthwise central part of the holding frame 72, whereby the correcting stretch roll 65 is tiltable three-dimensionally, as described above.

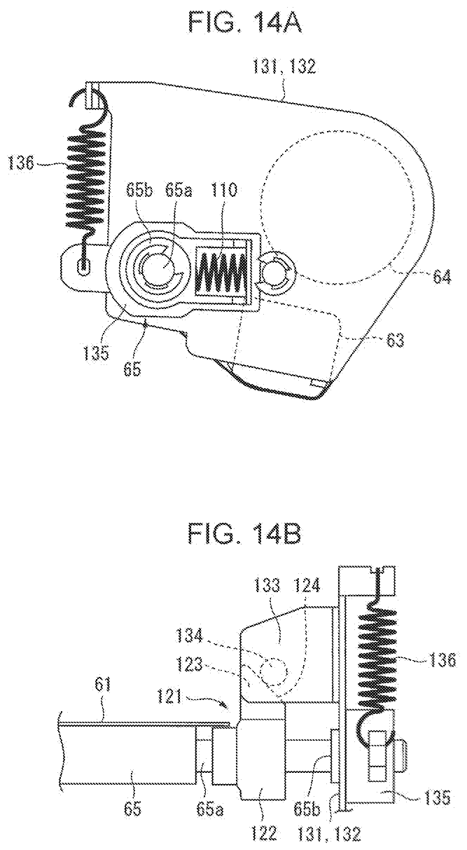

Skew Correcting Technique II for the fixing belt 61 according to the present exemplary embodiment employs edge guides 121, as illustrated in FIGS. 13A and 13B and FIGS. 14A and 14B. The edge guides 121 serve as edge receiving components provided facing the two respective widthwise edges of the fixing belt 61. The edge guides 121 are pierced through by respective rotation shafts 65a, which are provided at the two respective ends of the correcting stretch roll 65. The edge guides 121 are movable along the rotation shafts 65a. If either of the edge guides 121 receives the fixing belt 61 that is skewed widthwise, the edge guides 121 move in the direction of the rotation axis of the correcting stretch roll 65.

In Skew Correcting Technique II, the edge guides 121 each include a ring-shaped pulley 122. The pulley 122 is movable along the rotation shaft 65a of the correcting stretch roll 65. The pulley 122 includes at the top thereof a guiding projection 123, which receives the edge of the fixing belt 61. The guiding projection 123 has a slope 124, which is provided on the outer side in the thicknesswise direction of the pulley 122 and extends obliquely downward.

Skew Correcting Technique II further employs a tilt adjusting mechanism 130, which serves as a tilt adjusting component configured to adjust, in correspondence with the lengths of movements of the edge guides 121, the tilt of the correcting stretch roll 65 in such a manner as to reduce the skew of the fixing belt 61.

In Skew Correcting Technique II, a front frame 131 and a rear frame 132 are provided on the two respective axial sides of the correcting stretch roll 65 and form the housing of the belt unit. In the tilt adjusting mechanism 130, runners 134 are supported, while being allowed to rotate, on the inner side of the front frame 131 and the rear frame 132 with the aid of respective brackets 133. The runners 134 are pressed against the slopes 124 of the respective guiding projections 123.

The set of runners 134 serves as a linking component configured to work in conjunction with the movements of the edge guides 121 in such a manner as to tilt the correcting stretch roll 65.

Furthermore, the front frame 131 and the rear frame 132 are each provided on the outer side thereof with a rockable rocking arm 135. The rocking arm 135 has a recess in which a bearing 65b is movably placed. The bearing 65b bears a corresponding one of the rotation shafts 65a of the correcting stretch roll 65. Between the tip of the rocking arm 135 and the upper edge of the front frame 131 (or the rear frame 132) is stretched an elastic supporting spring 136, which serves as an elastic supporting component. The elastic supporting spring 136 urges the rocking arm 135 upward about a pivot. Since the rocking arms 135 are pulled upward, the correcting stretch roll 65 is pulled upward, whereby the slopes 124 at the guiding projections 123 of the respective edge guides 121 come into contact with the respective runners 134. That is, in Skew Correcting Technique II, the elastic supporting springs 136 keep exerting predetermined pressures in such a manner as to press the edge guides 121 against the two respective widthwise edges of the fixing belt 61.

In Skew Correcting Technique II, the rotation shafts 65a of the correcting stretch roll 65 are placed in the recesses of the respective rocking arms 135 with the aid of the respective bearings 65b so as to be movable. The rotation shafts 65a of the correcting stretch roll 65, together with the bearings 65b, are urged by respective urging springs 110 toward the fixing belt 61, whereby a tension is applied to the fixing belt 61.

In Skew Correcting Technique II for the fixing belt 61 according to the present exemplary embodiment, when the correcting stretch roll 65 is in a neutral orientation with no tilt, as illustrated in FIG. 13A, the edge guides 121 are pushed inward in the axial direction of the correcting stretch roll 65 while receiving pressures generated with the urging forces of the elastic supporting springs 136. Thus, the edge guides 121 are positioned by being pressed against the respective widthwise edges of the fixing belt 61.

In this state, as illustrated in FIG. 13B, if the fixing belt 61 is skewed toward one side as indicated by an arrow, a corresponding one of the widthwise edges of the fixing belt 61 pushes the guiding projection 123 of a corresponding one of the edge guides 121. Accordingly, a corresponding one of the runners 134 comes into contact with the slope 124 of the corresponding edge guide 121, and the edge guide 121 is moved outward. Consequently, the edge guide 121 is pushed downward, whereby an end of the correcting stretch roll 65 that is on the one side (the right side in the drawing) is lowered. On the other side of the correcting stretch roll 65, the force exerted by the elastic supporting spring 136 moves the runner 134 obliquely downward along the slope 124, whereby the edge guide 121 is lifted. Thus, the correcting stretch roll 65 is tilted downward on the one side (the right side in the drawing).

To summarize, when the correcting stretch roll 65 is tilted, the elastic supporting springs 136 undergo respective elastic deformations and thus exert respective elastic restoring forces, whereby the tilt of the correcting stretch roll 65 is automatically adjusted. Note that the correcting stretch roll 65 tilts three-dimensionally on the pivot defined in the support 73 provided at an axially central part of the correcting stretch roll 65.

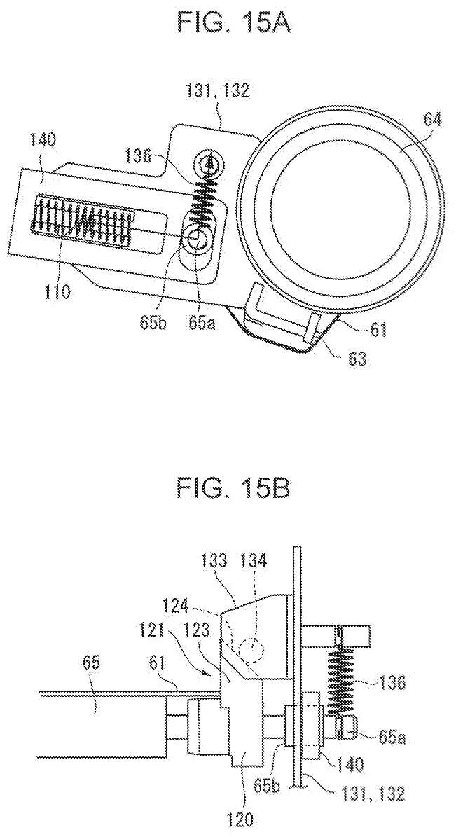

Another example of the passive steering scheme, different from the one illustrated in FIGS. 14A and 14B, is illustrated in FIGS. 15A and 15B.

In this example, the edge guides 121 and the runners 134 are the same as those illustrated in FIGS. 14A and 14B. Some other elements are different from those illustrated in FIGS. 14A and 14B. Specifically, the front frame 131 and the rear frame 132 are each provided on the outer side thereof with a bearing holder 140. The bearing holder 140 is slidable in the urging direction of the urging spring 110 provided for tension application. The bearing holder 140 has a recess in which the rotation shaft 65a of the correcting stretch roll 65 and the bearing 65b are placed. Between an end of the rotation shaft 65a and an upper part of the front frame 131 (or the rear frame 132) is stretched the elastic supporting spring 136 in a tensed manner. The urging spring 110 is provided in a compressed manner between the bearing holder 140 and a part of the front frame 131 (or the rear frame 132). Thus, the bearing holder 140 presses the correcting stretch roll 65 against the fixing belt 61, whereby a tension is applied to the fixing belt 61.

In such a scheme as well, the correcting stretch roll 65 is to be tilted in such a manner as to correct any skew of the fixing belt 61, as illustrated in FIGS. 13A and 13B. Note that the correcting stretch roll 65 tilts three-dimensionally on the pivot defined in the support 73 provided at an axially central part of the correcting stretch roll 65.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A belt supporting roll configured to support an endless belt while allowing the belt to rotate, the belt supporting roll comprising:
a roll body around which the belt is to be wrapped;
a holding component extending in an axial direction of the roll body and holding two ends of the roll body while allowing the roll body to rotate; and
a supporting component provided at a lengthwise central part of the holding component and supporting the roll body and the holding component while being movable,
wherein the supporting component has a range of motion containing a first directional component and a second directional component, the first directional component intersecting a bisector of a central angle of an angular range by which the belt is to be wrapped around the roll body, the second directional component being parallel to the bisector.
   (((2)))

The belt supporting roll according to (((1))),
wherein the supporting component includes a shaft member and a bearing member, the shaft member being positioned at the lengthwise central part of the holding component and across the holding component from the roll body, the shaft member including a spherical part that has a spherical outer peripheral surface, the bearing member bearing the spherical part of the shaft member while allowing the spherical part to rotate three-dimensionally.
   (((3)))

The belt supporting roll according to (((2))),
wherein the supporting component is oriented with the shaft member facing the holding component and with the bearing member being positioned on a predetermined fixed part.
   (((4)))

The belt supporting roll according to (((3))),
wherein the shaft member includes a projecting part projecting from the lengthwise central part of the holding component, with the spherical part being provided as a portion of the projecting part in such a manner as to protrude spherically.
   (((5)))

The belt supporting roll according to (((4))),
wherein the spherical part of the shaft member is provided at an end of the projecting part.
   (((6)))

The belt supporting roll according to any one of (((2))) to (((5))),
wherein the bearing member has a spherical bearing surface that holds the spherical part in such a manner as to surround the spherical part while allowing the spherical part to rotate.
   (((7)))

The belt supporting roll according to any one of (((2))) to (((5))),
wherein the bearing member is a cylindrical member having an inner peripheral bearing surface that circumscribes the spherical part of the shaft member.
   (((8)))

The belt supporting roll according to any one of (((2))) to (((7))),
wherein the bearing member is detachable from the shaft member.
   (((9)))

A belt rotating device comprising:
an endless belt; and
a plurality of belt supporting rolls that support the belt while allowing the belt to rotate,
wherein one of the plurality of belt supporting rolls is the belt supporting roll according to any one of (((1))) to (((8))).
   (((10)))

The belt rotating device according to (((9))), further comprising:
a detector configured to detect any skew of the belt in a widthwise direction that intersects a direction of rotation of the belt; and
a tilt adjusting component configured to adjust, with reference to a result of detection by the detector, a tilt of the belt supporting roll in such a manner as to reduce the skew of the belt.
   (((11)))

The belt rotating device according to (((9))), further comprising:
edge receiving components provided facing two respective widthwise edges of the belt and being movable in a widthwise direction of the belt, the edge receiving components being moved by the belt if the belt is skewed widthwise; and
a tilt adjusting component configured to adjust, in correspondence with lengths of movements of the edge receiving components, a tilt of the belt supporting roll in such a manner as to reduce a skew of the belt.
   (((12)))

The belt rotating device according to (((11))),
wherein the tilt adjusting component includes a linking component and elastic supporting components, the linking component being configured to tilt the belt supporting roll in conjunction with the movements of the edge receiving components, the elastic supporting components supporting two respective ends of the belt supporting roll while being elastically deformable, and
wherein the elastic supporting components are configured to adjust, if the belt supporting roll is tilted by the linking component, the tilt of the belt supporting roll with elastic restoring forces exerted by the elastic supporting components undergoing elastic deformations.
   (((13)))

The belt rotating device according to (((12))),
wherein the edge receiving components are positioned on a virtual line parallel to an axis of the belt supporting roll, and
wherein the elastic supporting components keep exerting pressures in such a manner as to press the respective edge receiving components against the two respective widthwise edges of the belt.
   (((14)))

The belt rotating device according to any one of (((9))) to (((13))),
wherein the belt supporting roll includes a tension adjusting component configured to urge the belt in the second directional component.
   (((15)))

The belt rotating device according to any one of (((9))) to (((14))), further comprising:
a processing component configured to perform a predetermined processing operation on a workpiece that moves by being in contact with the belt.
   (((16)))

A processing system comprising:
the belt rotating device according to (((15))); and
a transporting component configured to transport a workpiece to the belt rotating device and to transport the workpiece processed on the belt rotating device.

What is claimed is:

1. A belt supporting roll configured to support an endless belt while allowing the belt to rotate, the belt supporting roll comprising:
a roll body around which the belt is to be wrapped;
a holding component extending in an axial direction of the roll body and holding two ends of the roll body while allowing the roll body to rotate; and
a supporting component provided at a lengthwise central part of the holding component and supporting the roll body and the holding component while being movable,
wherein the supporting component has a range of motion containing a first directional component and a second directional component, the first directional component intersecting a bisector of a central angle of an angular range by which the belt is to be wrapped around the roll body, the second directional component being parallel to the bisector.

2. The belt supporting roll according to claim 1,
wherein the supporting component includes a shaft member and a bearing member, the shaft member being positioned at the lengthwise central part of the holding component and across the holding component from the roll body, the shaft member including a spherical part that has a spherical outer peripheral surface, the bearing member bearing the spherical part of the shaft member while allowing the spherical part to rotate three-dimensionally.

3. The belt supporting roll according to claim 2,
wherein the supporting component is oriented with the shaft member facing the holding component and with the bearing member being positioned on a predetermined fixed part.

4. The belt supporting roll according to claim 3,
wherein the shaft member includes a projecting part projecting from the lengthwise central part of the holding component, with the spherical part being provided as a portion of the projecting part in such a manner as to protrude spherically.

5. The belt supporting roll according to claim 4,
wherein the spherical part of the shaft member is provided at an end of the projecting part.

6. The belt supporting roll according to claim 2,
wherein the bearing member has a spherical bearing surface that holds the spherical part in such a manner as to surround the spherical part while allowing the spherical part to rotate.

7. The belt supporting roll according to claim 2,
wherein the bearing member is a cylindrical member having an inner peripheral bearing surface that circumscribes the spherical part of the shaft member.

8. The belt supporting roll according to claim 2,
wherein the bearing member is detachable from the shaft member.

9. A belt rotating device comprising:
an endless belt; and
a plurality of belt supporting rolls that support the belt while allowing the belt to rotate,
wherein one of the plurality of belt supporting rolls is the belt supporting roll according to claim 1.

10. A belt rotating device comprising:
an endless belt; and
a plurality of belt supporting rolls that support the belt while allowing the belt to rotate,
wherein one of the plurality of belt supporting rolls is the belt supporting roll according to claim 2.

11. A belt rotating device comprising:
an endless belt; and
a plurality of belt supporting rolls that support the belt while allowing the belt to rotate,
wherein one of the plurality of belt supporting rolls is the belt supporting roll according to claim 3.

12. A belt rotating device comprising:
an endless belt; and
a plurality of belt supporting rolls that support the belt while allowing the belt to rotate,
wherein one of the plurality of belt supporting rolls is the belt supporting roll according to claim 4.

13. A belt rotating device comprising:
an endless belt; and
a plurality of belt supporting rolls that support the belt while allowing the belt to rotate,
wherein one of the plurality of belt supporting rolls is the belt supporting roll according to claim 5.

14. The belt rotating device according to claim 9, further comprising:
a detector configured to detect any skew of the belt in a widthwise direction that intersects a direction of rotation of the belt; and
a tilt adjusting component configured to adjust, with reference to a result of detection by the detector, a tilt of the belt supporting roll in such a manner as to reduce the skew of the belt.

15. The belt rotating device according to claim 9, further comprising:
edge receiving components provided facing two respective widthwise edges of the belt and being movable in a widthwise direction of the belt, the edge receiving components being moved by the belt if the belt is skewed widthwise; and
a tilt adjusting component configured to adjust, in correspondence with lengths of movements of the edge receiving components, a tilt of the belt supporting roll in such a manner as to reduce a skew of the belt.

16. The belt rotating device according to claim 15,
wherein the tilt adjusting component includes a linking component and elastic supporting components, the linking component being configured to tilt the belt supporting roll in conjunction with the movements of the edge receiving components, the elastic supporting components supporting two respective ends of the belt supporting roll while being elastically deformable, and
wherein the elastic supporting components are configured to adjust, if the belt supporting roll is tilted by the linking component, the tilt of the belt supporting roll with elastic restoring forces exerted by the elastic supporting components undergoing elastic deformations.

17. The belt rotating device according to claim 16,
wherein the edge receiving components are positioned on a virtual line parallel to an axis of the belt supporting roll, and
wherein the elastic supporting components keep exerting pressures in such a manner as to press the respective edge receiving components against the two respective widthwise edges of the belt.

18. The belt rotating device according to claim 9,
wherein the belt supporting roll includes a tension adjusting component configured to urge the belt in the second directional component.

19. The belt rotating device according to claim 9, further comprising:
a processing component configured to perform a predetermined processing operation on a workpiece that moves by being in contact with the belt.

20. A processing system comprising:
the belt rotating device according to claim 19; and
a transporting component configured to transport a workpiece to the belt rotating device and to transport the workpiece processed on the belt rotating device.
